(19) United States
(12) Patent Application Publication
(10) Pub. No.: US 2025/0245033 A1
(43) Pub. Date: Jul. 31, 2025

(54) SYSTEMS AND METHODS FOR PROVIDING DATA MOBILITY WITH HETEROGENEOUS MULTI-CLOUD PLATFORMS

(71) Applicant: Dell Products L.P., Round Rock, TX (US)

(72) Inventors: Gopakumar Ambat, Bangalore (IN); Matthew P. Jean, Shirley, MA (US)

(73) Assignee: Dell Products L.P., Round Rock, TX (US)

(21) Appl. No.: 18/422,200

(22) Filed: Jan. 25, 2024

(51) Int. Cl. G06F 9/455

(52) U.S. Cl. CPC G06F 9/45558; G06F 2009/45583

(57) ABSTRACT

According to one embodiment, an Information Handling System (IHS) includes a multi-cloud platform including first and second clouds each supported by first and second servers, respectively, and computer-executable instructions. The instructions may be executed to receive, by the common workflow service, a request to copy storage data from a first server to a second server, communicate, by the common workflow service, with a first server specific adapter service associated with the first server to obtain the storage data from the first server, and communicate, by the common workflow service, with a second server specific adapter service associated with the second server to store the obtained storage data in the second server. The common workflow service is agnostic to the specific procedures used by the first and second servers, which are heterogeneous relative to one another.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

IHSs may be general or configured for a specific user or specific use, such as financial transaction processing, airline reservations, enterprise data storage, or global communications. In addition, IHSs may include a variety of hardware and software components that may be configured to process, store, and communicate information and may include one or more computer systems, data storage systems, and networking systems.

Many computer processing architectures have recently migrated toward cloud computing. Cloud computing generally involves the delivery of computing services over the Internet. Whereas on-premises computing solutions can refer to in-house hosted software (e.g., on local servers, private clouds, etc.) that may be supported by a third party vendor or provider, cloud computing solutions may refer to software that is hosted and maintained by the same vendor. With cloud computing, a virtualized pool of resources, from raw compute power at the infrastructure level to application functionality, is often made available to a client, on demand, by a provider. One particular advantage of cloud computing is the ability to apply abstracted versions of compute, storage, and network resources to workloads, as needed, and tap into an abundance of prebuilt services. Cloud computing may enable users to tap into additional capabilities without requiring the investment of the infrastructure, such as new hardware or software. Rather, users often pay the provider of the cloud service a subscription fee or in some cases lease the infrastructure that they use.

Multi-cloud computing refers to the use of two or more clouds from different cloud providers. This may include any mix of Infrastructure, Platform, or Software as a Service (IaaS, PaaS, or SaaS). Multi-cloud computing may be used to address specific business requirements or to avoid the limitations of a single-vendor cloud strategy. For example, the use of cloud services and computing resources for business that depends on a single cloud has caused various problems, such as a risk of service interruption of the single cloud. The multi-cloud platform may include cloud networks or cloud hosting environments provided by different cloud service providers. In the multi-cloud platform, the cloud networks may be managed by a multi-cloud management platform. The multi-cloud management platform includes hardware, software, firmware, or a combination thereof which provides a unified interface for deployment, provisioning, and monitoring of different cloud networks in the multi-cloud platform.

### SUMMARY

Systems and methods for data mobility in multi-cloud platforms provide an adapter service for each storage server that orchestrates endpoint specific logic so that a common workflow service can provide overall mobility orchestration steps. According to one embodiment, an Information Handling System (IHS) includes a multi-cloud platform including first and second clouds each supported by first and second servers, respectively, and computer-executable instructions. The instructions may be executed to receive, by the common workflow service, a request to copy storage data from a first server to a second server, communicate, by the common workflow service, with a first server specific adapter service associated with the first server to obtain the storage data from the first server, and communicate, by the common workflow service, with a second server specific adapter service associated with the second server to store the obtained storage data in the second server. The common workflow service is agnostic to the specific procedures used by the first and second servers, which are heterogeneous relative to one another.

According to another embodiment, a data mobility method includes the steps of receiving, by a common workflow service, a request to copy storage data from a first server to a second server, communicating, by the common workflow service, with a first server specific adapter service associated with the first server to obtain the storage data from the first server, and communicating, by the common workflow service, with a second server specific adapter service associated with the second server to store the obtained storage data in the second server. The common workflow service is agnostic to the specific procedures used by the first and second servers, and the first and second servers are heterogeneous relative to one another and support first and second clouds, respectively, of a multi-cloud platform.

According to yet another embodiment, a computer program product includes a non-transitory computer readable storage medium having program instructions stored thereon that, upon execution by an IHS, cause the IHS to receive, by a common workflow service, a request to copy storage data from a first server to a second server, communicate, by the common workflow service, with a first server specific adapter service associated with the first server to obtain the storage data from the first server, and communicate, by the common workflow service, with a second server specific adapter service associated with the second server to store the obtained storage data in the second server.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 illustrates an example data mobility system that provides data mobility for heterogeneous multi-cloud platforms according to one embodiment of the present disclosure.

FIG. 2 is a block diagram of components of an IHS, of which one or more may be used to implement embodiments of the data mobility system of FIG. 1.

FIG. 3 illustrates a detailed view of several components of the data mobility system according to one embodiment of the present disclosure.

FIG. 4 illustrates an example data mobility method that may be performed by the data mobility system to copy storage data from a first source storage server to a second target storage server according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Cloud computing generally refers to the delivery of computing resources, especially data storage and computing power, over the Internet without direct active management by the user. The term is generally used to describe data centers available to many users on a pay-for-use basis. As an increasing number of software applications are moving to the cloud and are being developed for the cloud, users are adopting a variety of cloud deployment models. These range from private clouds to public clouds, to a mix of both (i.e., hybrid clouds).

Multi-cloud computing generally refers to the use of at least two or more cloud environments at the same time, and may also refer to the use of two or more clouds from different cloud providers. This may include any mix of Infrastructure, Platform, or Software as a Service (IaaS, PaaS, or SaaS). The term “cloud platform” may be used herein to refer to a configuration of distributed storage and/or computing services that may be publicly offered by providers over the Internet. Examples for such cloud platforms may include Amazon Web Services (AWS), Microsoft Azure, and Google Cloud Platform (GCP).

Computing vendors are working on the delivery of systems that allow customers to easily leverage various storage offerings across today's available computing environments. One goal is to provide customer with the options to run storage offerings with various public cloud providers and provide a platform that allows for those systems to be managed centrally while also available to the rest of the enterprise environment for workflows and data/application mobility. In particular, it would be beneficial for vendors of cloud computing resources to scale access to cloud computing platform accounts outside the purview or control of the cloud platform's control mechanisms.

Multi-cloud management tools have been developed to address the need of providing a multi-cloud platform for users. As these tools start supporting different storage endpoints across different storage types (e.g., block storage, file storage, object storage, etc.) and heterogeneous storage systems, it has become increasingly challenging to organize the mobility related business logic across all these diverse systems. IHS vendors have developed storage systems that are optimized for different purposes thus yielding different procedures or processes for handling data mobility. For example, DELL TECHNOLOGIES has developed a POWERFLEX line of storage systems that is optimized for scalable block and file capabilities, a POWERMAX line optimized for reliability, a POWERSCALE line that includes object storage support, and a POWERSTORE line that provides software-defined storage. Each of these systems often use different data mobility procedures due to their inherently different design.

This problem may be exacerbated by the fact that there is no one single definition of how each storage server (e.g., storage endpoint) implements its snapshot management, volume management, or copy management routines. Additionally, continual, ongoing updates (e.g., churn) in these server endpoint Application Program Interfaces (APIs) across their various releases often require Information Technology Decision Makers (ITDMs) to continually update their data mobility procedures. As such, it would be beneficial for Data Mobility (DM) workflows and sequences to remain agnostic of the storage endpoint specific operations so that the multi-cloud management tools can scale up to support mobility across heterogeneous endpoints.

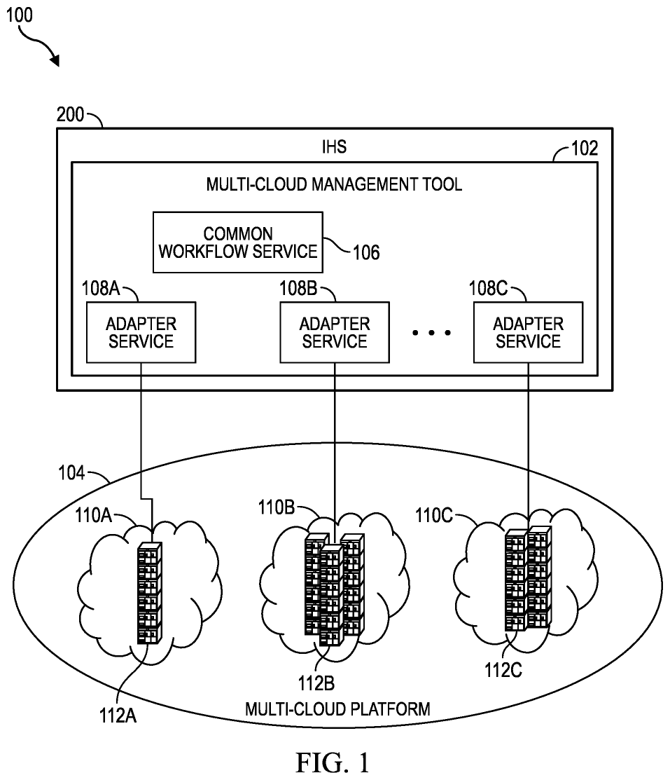

FIG. 1 illustrates an example data mobility system 100 that provides data mobility for heterogeneous multi-cloud platforms according to one embodiment of the present disclosure. The data mobility system 100 includes a Multi-cloud management tool 102 configured to manage the operation of a multi-cloud platform 104. According to embodiments of the present disclosure, the multi-cloud management tool 102 is configured with a common workflow service 106 and multiple adapter services 108 that are each adapted to implement data mobility workflows unique to the infrastructure of each constituent cloud 110 of the multi-cloud platform 104.

The multi-cloud platform 104 communicates with each adapter service 108 through a network, such as the Internet, and may be embodied as instructions stored in a memory and executed by one or more IHSs 200, such as the IHS 200 described herein below. Each cloud 110 may be managed and operated by a service provider on behalf of the one or more organizations. For example, a cloud 110a may be managed and operated by the service provider on behalf of a first organization, while cloud 110b may be managed and operated by the service provider on behalf of a second, different organization. In some cases, more than one cloud 110 may be managed and operated on behalf of a single organization. Each cloud 110 may include a public cloud platform (e.g., AMAZON WEB SERVICES, MICROSOFT AZURE, GOOGLE CLOUD PLATFORM, etc.), or privately held cloud platform. For example, a private cloud may be internally managed by, or on behalf of, the enterprise (e.g., organization, company, group, person, etc.) that deploys it.

Each cloud 110 is supported by infrastructure in the form of one or more servers 112a-c (collectively 112) or other type of computer, storage device, or other processing platform element. For example, server 112a may include at least one POWERSTORE storage server, server 112b may include at least one POWERFLEX storage server, while server 112c may include at least one POWERSCALE storage server provided by DELL TECHNOLOGIES. As will be described in detail herein below, the adapter service 108 orchestrates endpoint specific logic so that the common workflow service 106 can provide overall mobility orchestration steps for performing data mobility.

An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components.

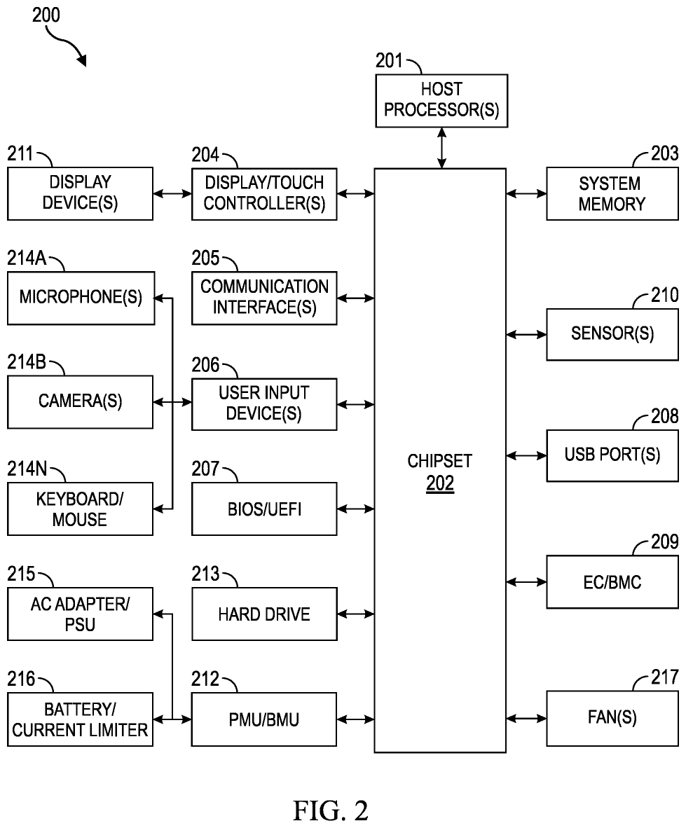

FIG. 2 is a block diagram of components of an IHS 200, of which one or more may be used to implement embodiments of the data mobility system of FIG. 1. As depicted, IHS 200 includes host processor(s) 201. In various embodiments, IHS 200 may be a single-processor system, a multi-processor system including two or more processors, and/or a heterogeneous computing platform. Host processor(s) 201 may include any processor capable of executing program instructions, such as a PENTIUM processor, or any general-purpose or embedded processor implementing any of a variety of Instruction Set Architectures (ISAs), such as an x86 or a Reduced Instruction Set Computer (RISC) ISA (e.g., POWERPC, ARM, SPARC, MIPS, etc.).

IHS 200 includes chipset 202 coupled to host processor(s) 201. Chipset 202 may provide host processor(s) 201 with access to several resources. In some cases, chipset 202 may utilize a QuickPath Interconnect (QPI) bus to communicate with host processor(s) 201.

Chipset 202 may also be coupled to communication interface(s) 205 to enable communications between IHS 200 and various wired and/or wireless networks, such as Ethernet, WiFi, BLUETOOTH (BT), cellular or mobile networks (e.g., Code-Division Multiple Access or “CDMA,” Time-Division Multiple Access or “TDMA,” Long-Term Evolution or “LTE,” etc.), satellite networks, or the like.

Communication interface(s) 205 may also be used to communicate with certain peripherals devices (e.g., BT speakers, microphones, headsets, etc.). Moreover, communication interface(s) 205 may be coupled to chipset 202 via a Peripheral Component Interconnect Express (PCIe) bus, or the like.

Chipset 202 may be coupled to display/touch controller(s) 204, which may include one or more Graphics Processor Units (GPUs) on a graphics bus, such as an Accelerated Graphics Port (AGP) or PCIe bus. As shown, display/touch controller(s) 204 provide video or display signals to one or more display device(s) 211.

Display device(s) 211 may include Liquid Crystal Display (LCD), Light Emitting Diode (LED), organic LED (OLED), or other thin film display technologies. Display device(s) 211 may include a plurality of pixels arranged in a matrix, configured to display visual information, such as text, two-dimensional images, video, three-dimensional images, etc. In some cases, display device(s) 211 may be provided as a single continuous display, or as two or more discrete displays.

Chipset 202 may provide host processor(s) 201 and/or display/touch controller(s) 204 with access to system memory 203. In various embodiments, system memory 203 may be implemented using any suitable memory technology, such as static RAM (SRAM), dynamic RAM (DRAM) or magnetic disks, or any nonvolatile/Flash-type memory, such as a solid-state drive (SSD) or the like.

Chipset 202 may also provide host processor(s) 201 with access to one or more Universal Serial Bus (USB) ports 208, to which one or more peripheral devices may be coupled (e.g., integrated or external webcams, microphones, speakers, etc.).

Chipset 202 may further provide host processor(s) 201 with access to one or more hard disk drives, solid-state drives, optical drives, or other removable-media drives 213.

Chipset 202 may also provide access to one or more user input devices 206, for example, using a super 1/O controller or the like. Examples of user input devices 206 may include, but are not limited to, microphone(s) 214A, camera(s) 214B, and keyboard/mouse 214N. Other user input devices 206 may include a touchpad, trackpad, stylus or active pen, totem, etc.

Each user input devices 206 may include a respective controller (e.g., a touchpad may have its own touchpad controller) that interfaces with chipset 202 through a wired or wireless connection (e.g., via communication interfaces(s) 205). In some cases, chipset 202 may also provide access to one or more user output devices (e.g., video projectors, paper printers, 3D printers, loudspeakers, audio headsets, Virtual/Augmented Reality (VR/AR) devices, etc.). In certain embodiments, chipset 202 may further provide an interface for communications with hardware sensors 210.

Sensors 210 may be disposed on or within the chassis of IHS 200, or otherwise coupled to IHS 200, and may include, but are not limited to: electric, magnetic, radio, optical (e.g., camera, webcam, etc.), infrared, thermal (e.g., thermistors etc.), force, pressure, acoustic (e.g., microphone), ultrasonic, proximity, position, deformation, bending, direction, movement, velocity, rotation, gyroscope, Inertial Measurement Unit (IMU), and/or acceleration sensor(s).

The Unified Extensible Firmware Interface (UEFI) was designed as a successor to BIOS. As a result, many modern IHSs utilize UEFI in addition to or instead of a BIOS. As used herein, BIOS 207 is intended to also encompass a UEFI component.

Embedded Controller (EC) or Baseboard Management Controller (BMC) 209 is operational from the very start of each IHS power reset and handles various tasks not ordinarily handled by host processor(s) 201. Examples of these operations may include, but are not limited to: receiving and processing signals from a keyboard or touchpad, as well as other buttons and switches (e.g., power button, laptop lid switch, etc.), receiving and processing thermal measurements (e.g., performing fan control, CPU and GPU throttling, and emergency shutdown), controlling indicator LEDs (e.g., caps lock, scroll lock, number lock, battery, power, wireless LAN, sleep, etc.), managing PMU/BMU 212, alternating current (AC) adapter/Power Supply Unit (PSU) 215 and/or battery/current limiter 216, allowing remote diagnostics and remediation over network(s) 104, etc. For example, EC/BMC 209 may implement operations for interfacing with power adapter/PSU 215 in managing power for IHS 200. Such operations may be performed to determine the power status of IHS 200, such as whether IHS 200 is operating from AC adapter/PSU 215 and/or battery 216.

Firmware instructions utilized by EC/BMC 209 may also be used to provide various core operations of IHS 200, such as power management and management of certain modes of IHS 200 (e.g., turbo modes, maximum operating clock frequencies of certain components, etc.). In addition, EC/BMC 209 may implement operations for detecting certain changes to the physical configuration or posture of IHS 200. For instance, when IHS 200 is embodied as a 2-in-1 laptop/tablet form factor, EC/BMC 209 may receive inputs from a lid position or hinge angle sensor 210, and it may use those inputs to determine: whether the two sides of IHS 200 have been latched together to a closed position or a tablet position, the magnitude of a hinge or lid angle, etc. In response to these changes, the EC may enable or disable certain features of IHS 200 (e.g., front or rear facing camera, etc.).

In some cases, EC/BMC 209 may be configured to identify any number of IHS postures, including, but not limited to: laptop, stand, tablet, tent, or book. For example, when display(s) 211 of IHS 200 is open with respect to a horizontal keyboard portion, and the keyboard is facing up, EC/BMC 209 may determine IHS 200 to be in a laptop posture. When display(s) 211 of IHS 200 is open with respect to the horizontal keyboard portion, but the keyboard is facing down (e.g., its keys are against the top surface of a table), EC/BMC 209 may determine IHS 200 to be in a stand posture.

When the back of display(s) 211 is closed against the back of the keyboard portion, EC/BMC 209 may determine IHS 200 to be in a tablet posture. When IHS 200 has two display(s) 211 open side-by-side, EC/BMC 209 may determine IHS 200 to be in a book posture. When IHS 200 has two displays open to form a triangular structure sitting on a horizontal surface, such that a hinge between the displays is at the top vertex of the triangle, EC/BMC 209 may determine IHS 200 to be in a tent posture. In some implementations, EC/BMC 209 may also determine if display(s) 211 of IHS 200 are in a landscape or portrait orientation. In some cases, EC/BMC 209 may be installed as a Trusted Execution Environment (TEE) component to the motherboard of IHS 200.

Additionally, or alternatively, EC/BMC 209 may be configured to calculate hashes or signatures that uniquely identify individual components of IHS 200. In such scenarios, EC/BMC 209 may calculate a hash value based on the configuration of a hardware and/or software component coupled to IHS 200. For instance, EC/BMC 209 may calculate a hash value based on all firmware and other code or settings stored in an onboard memory of a hardware component.

Hash values may be calculated as part of a trusted process of manufacturing IHS 200 and may be maintained in secure storage as a reference signature. EC/BMC 209 may later recalculate the hash value for a component, compare it against the reference hash value to determine if any modifications have been made to the component, thus indicating that the component has been compromised. In this manner, EC/BMC 209 may validate the integrity of hardware and software components installed in IHS 200.

In various embodiments, IHS 200 may be coupled to an external power source (e.g., AC outlet or mains) through an AC adapter/PSU 215. AC adapter/PSU 215 may include an adapter portion having a central unit (e.g., a power brick, wall charger, or the like) configured to draw power from an AC outlet via a first electrical cord, convert the AC power to direct current (DC) power, and provide DC power to IHS 200 via a second electrical cord.

Additionally, or alternatively, AC adapter/PSU 215 may include an internal or external power supply portion (e.g., a switching power supply, etc.) connected to the second electrical cord and configured to convert AC to DC. AC adapter/PSU 215 may also supply a standby voltage, so that most of IHS 200 can be powered off after preparing for hibernation or shutdown, and powered back on by an event (e.g., remotely via wake-on-LAN, etc.). In general, AC adapter/PSU 215 may have any specific power rating, measured in volts or watts, and any suitable connectors.

IHS 200 may also include internal or external battery 216. Battery 216 may include, for example, a Lithium-ion or Li-ion rechargeable device capable of storing energy sufficient to power IHS 200 for an amount of time, depending upon the IHS's workloads, environmental conditions, etc. In some cases, a battery pack may also contain temperature sensors, voltage regulator circuits, voltage taps, and/or charge-state monitors. For example, battery 216 may include a current limiter, or the like.

In some embodiments, battery 216 may be configured to detect overcurrent or undervoltage conditions using Limits Management Hardware (LMH). As used herein, the term “overcurrent” refers to a condition in an electrical circuit that arises when a normal load current is exceeded (e.g., overloads, short circuits, etc.). Conversely, the term “undervoltage” refers to a condition (e.g., “brownout”) where the applied voltage drops to X % of rated voltage (e.g., 90%), or less, for a predetermined amount of time (e.g., 1 minute).

Power Management Unit (PMU) 212 governs power functions of IHS 200, including AC adapter/PSU 215 and battery 216. For example, PMU 212 may be configured to: monitor power connections and battery charges, charging batteries, control power to other components, devices, or ICs, shut down components when they are left idle, control sleep and power functions (On and Off), managing interfaces for built-in keypad and touchpads, regulate real-time clocks (RTCs), etc.

In some implementations, PMU 212 may include one or more Power Management Integrated Circuits (PMICs) configured to control the flow and direction or electrical power in IHS 200. Particularly, a PMIC may be configured to perform battery management, power source selection, voltage regulation, voltage supervision, undervoltage protection, power sequencing, and/or charging operations. It may also include a DC-to-DC converter to allow dynamic voltage scaling, or the like.

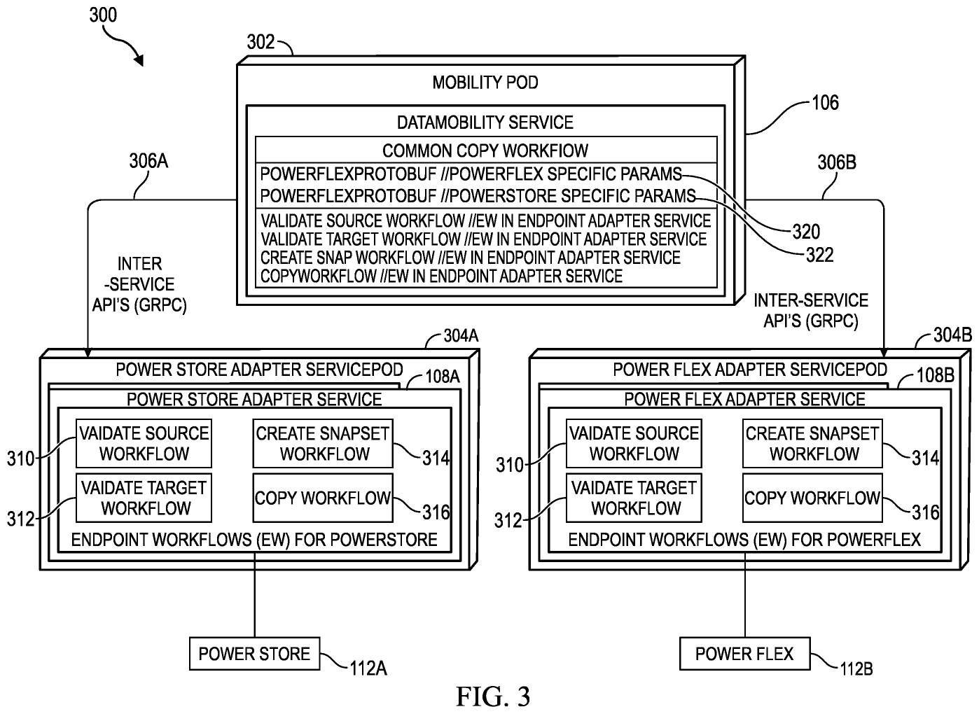

Additionally, or alternatively, PMU 212 may include a Battery Management Unit (BMU) (referred to collectively as “PMU/BMU 212”). AC adapter/PSU 215 may be removably coupled to a battery charge controller within PMU/BMU 212 to provide IHS 200 with a source of DC power from battery cells within battery 216 (e.g., a lithium ion (Li-ion) or nickel metal hydride (NiMH) battery pack including one or more rechargeable batteries). PMU/BMU 212 may include non-volatile memory and it may be configured to collect and store battery status, charging, and discharging information, and to provide that information to other IHS components, such as, for example devices within heterogeneous computing platform 300 (FIG. 3).

Examples of information collected and stored in a memory within PMU/BMU 212 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information (e.g., such as ambient temperature, relative humidity, system geolocation measured by GPS or triangulation, time and date, etc.), and BMU events.

Examples of BMU events may include, but are not limited to acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, power draw measurements may be conducted with control and monitoring of power supply via PMU/BMU 212. Power draw data may also be monitored with respect to individual components or devices of IHS 200. Whenever applicable, PMU/BMU 212 may administer the execution of a power policy, or the like.

IHS 200 may also include one or more fans 217 configured to cool down one or more components or devices of IHS 200 disposed inside a chassis, case, or housing. Fan(s) 217 may include any fan inside, or attached to, IHS 200 and used for active cooling. Fan(s) 217 may be used to draw cooler air into the case from the outside, expel warm air from inside, and/or move air across a heat sink to cool a particular IHS component. In various embodiments, both axial and sometimes centrifugal (blower/squirrel-cage) fans may be used.

In other embodiments, IHS 200 may not include all the components shown in FIG. 2. In other embodiments, IHS 200 may include other components in addition to those that are shown in FIG. 2. Furthermore, some components that are represented as separate components in FIG. 2 may instead be integrated with other components, such that all or a portion of the operations executed by the illustrated components may instead be executed by the integrated component.

For example, in various embodiments described herein, host processor(s) 201 and/or other components of IHS 200 (e.g., chipset 202, display/touch controller(s) 204, communication interface(s) 205, EC/BMC 209, etc.) may be replaced by discrete devices within a heterogeneous computing platform. As such, IHS 200 may assume different form factors including, but not limited to: servers, workstations, desktops, laptops, appliances, video game consoles, tablets, smartphones, etc.

FIG. 3 illustrates a detailed view of several components of the data mobility system 100 according to one embodiment of the present disclosure. In one embodiment, the common workflow service 106 and adapter services 108a-b (collectively 108) are each hosted by a KUBERNETES POD 302 and 304a-b, respectively. In other embodiments, the common workflow service 106 and adapter services 108 may be executed in any suitable platform. Additionally, the common workflow service 106 and adapter services 108 communicate with each other using inter-service APIs 306a-b (collectively 306), such as gRPC. In other embodiments, it is contemplated that the common workflow service 106 and adapter service 108 may communicate with one another using any suitable type of communication medium, and be hosted on any suitable computing platform.

As shown, the endpoint workflows (EWs) provided by each adapter service 108 include a validateSourceWorkflow 310 that validates a block, file, or object storage element of its respective storage server 112 that is to be copied from, a validateTargetWorkflow 312 that validates a block, file, or object storage element of its respective storage server 112 that is to be copied to, a createSnapshotWorkflow 314 that creates a snapshot of a block, file, or object storage element of its respective storage server 112, and a copyWorkflow 316 that handles copying of a block, file, or object storage element to or from its respective storage server 112. The common workflows provided by the common workflow service 106 include multiple header files, such as a powerFlexProtoBuf 320 and powerStoreProtoBuf 322 header files that store specific parameters used to communicate with the endpoint workflows in each adapter service 108.

Generally speaking, the common workflow service 106 and adapter service 108 separates the common mobility workflows from the endpoint specific business logic used by each storage server 112, which provides the infrastructure for its respective cloud 110. Common workflows (CW) are deployed in a separate pod 302 (e.g., microservice) separate from other pods 304 (e.g., microservices) that perform the endpoint workflows (EW). A set of interfaces are defined for interaction between the CW and the endpoint workflow, and protocol buffers, such as Google protobuf that support version control, are used to transfer data between the workflows. Each of the endpoint products (i.e., adapter service 108) deliver their specific endpoint workflows, which may be different from one another to their respective servers 112.

Common workflows provided by the common workflow service 106, orchestrate core mobility, may be stateful, and respond to requests from northbound APIs, such as requests issued via user input or due to other computer-executable processes. Common workflows provided by the common workflow service 106 may also parse any incoming requests, deciphers the endpoint it needs to interface with for a mobility operation and connects, via well-defined interfaces (i.e., gRPC channel 306), with the endpoint workflow associated with that adapter service 108. It should be important to note that for a single mobility operation, such as copy, the adapter service 108 involved could be of different types, such as copy operation that would be performed from POWERSTORE to POWERFLEX. Endpoint workflows provided by each adapter service 108, orchestrate endpoint specific logic, is stateless, and manages southbound communication to its respective storage server 112. Endpoint workflows are agnostic to the overall mobility orchestration steps and may also be unaware of whether mobility is between homogeneous or heterogeneous systems. The endpoint workflows provided by each adapter service 108 may be referred to as a mobility adapter due to the fact that they adapt the workflows to the specific procedures used by different, heterogeneous storage servers 112.

In one embodiment, all adapter services 108 implement the same set of endpoint workflows, and the common workflows included in the common workflow service 106 includes logic to determine which endpoint workflows on each adapter service 108 to invoke in order to provide the mobility services. To provide an example in which a source storage server 112 is a POWERSTORE storage server 112, and a target storage server 112 is a POWERFLEX storage server, the validateSourceWorkflow and validateTargetWorkflow may be implemented (e.g., used) on both POWERSTORE and POWERFLEX storage servers 112. Common workflows provided by the common workflow service 106, however, would only use the PowerFlexAdapterService workflow if the POWERFLEX is the source of a copy procedure. Likewise, in this case, common workflows may use the validateTargetWorkflow in the adapter service 108 since the POWERSTORE storage server 112 is the target of a copy procedure.

Embodiments of the present disclosure may provide certain advantages over conventional data mobility processes used with heterogeneous storage server 112. For example, the data mobility system 100 may provide development at scale with multiple adapter services 108 (endpoint) development personnel being able to develop their code in parallel. Endpoint workflow's provided by the adapter service 108 may be deployed as a microservice such that development personnel are able to update the business logic specific to each storage server 112 without having to know the particulars of any common workflows. Additionally, in a SaaS system, endpoint workflow is a service that is built and tested independently and delivered into the overall multi-cloud platform 104 development pipeline for integration. In one embodiment, each service provider (e.g., storage server 112 development team in the present case) would be responsible for their own product quality, thus ensuring that the business logic is maintained at a relatively high level of quality.

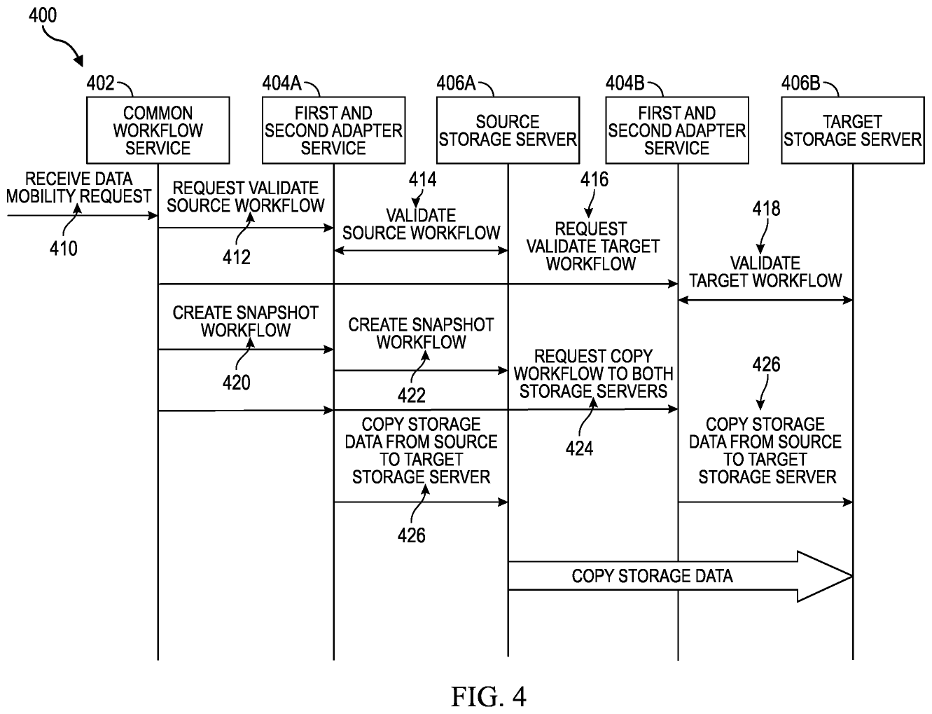

FIG. 4 illustrates an example data mobility method 400 that may be performed by the data mobility system 100 to copy storage data from a first source storage server 406a to a second target storage server 406b according to one embodiment of the present disclosure. The method 400 may be performed at any time storage data is to be copied from one cloud to another in a multi-cloud platform. Additionally or alternatively, the data mobility method 400 may be performed at least in part, by the data mobility system 100 as described herein above with reference to FIG. 1. Initially, an adapter service 404a-b (collectively 404) may be instantiated for each cloud that is to be utilized by the data mobility system 100.

At step 410, the common workflow service 402 receives a request to perform a copy operation from one cloud to another. The request could be manually received as a result of user input, or automatically generated by another computer-executed process. At step 412, the common workflow service 402 issues a request to the source adapter service 404a whose cloud is the source storage to perform the validateSourceWorkflow endpoint workflow 310. In response, the adapter service 108, at step 414, communicates with the source storage server 406a to validate the storage block, storage file, or storage object (collectively storage data) on the source storage server 406a. Validating the storage data may, for example, include ensuring that the storage data is free of any errors (e.g., bad sectors), is not overly fragmented, conforms to proper security policies, and the like.

At step 416, the common workflow service 402 issues a request to the target adapter service 404b whose cloud is the target of the storage data copy operation to perform the validateTargetWorkflow endpoint workflow 312. Thereafter at step 418, the target adapter service 404b validates the target storage server 406b. Validating the target storage server 406b may include, for example, verifying that the storage server 406b possesses sufficient available memory for receiving and storing the storage data from the source storage server 406a. The common workflow service 402 then issues a request to the source adapter service 404a whose cloud is the source of the storage data to perform the createSnapshotWorkflow endpoint workflow 314 at step 420. The source adapter service 404a in response creates a snapshot of the storage data to be copied at step 422. Creating the snapshot essentially ensures the integrity of the storage data by ensuring that no interim changes are made while it is being copied.

At step 424, the common workflow service 402 issues a request to both adapter services 404a-b to perform the copyWorkflow endpoint workflow 316. Thereafter at step 426, the source and target servers 406a-b function under control of their respective adapter services 404a-b to copy the storage data from the source storage server 406a to the target storage server 406b.

As mentioned previously, the copyWorkflow endpoint workflow 316 may be agnostic to the overall mobility orchestration steps and may also be unaware of whether mobility is between homogeneous or heterogeneous systems. As such, the copyWorkflow endpoint workflow 316 can concentrate on its principle purpose of adapting the storage type of its associated storage server 406a-b with that of other storage servers 406a-b, thus yielding a system that can be easily scaled.

Copying the storage data from the source storage server 406a to the target storage server 406b may involve converting its type (e.g., block storage, file storage, object storage) into another type, for example, due to limitations with the target storage server 406b that may not possess the ability to store the storage data with the type of storage used by the source storage server 406a. In one embodiment, the adapter services 406a-b may provide conversion of the storage data's type to one used by its associated storage server 406a-b. For example, the adapter service 406a-b of the source or target server 406a-b may convert from the storage data stored as object storage in source storage server 406a into block storage or file storage on the target storage server 406b.

The steps of the aforedescribed process may be performed each time a block of storage data is copied from one storage server 406a-b to another. Nevertheless, when use of the data mobility method 400 is no longer needed or desired, the process ends.

Although FIG. 4 describes an example method 400 that may be performed to copy storage data between heterogeneous servers, the features of the method 400 may be embodied in other specific forms without deviating from the spirit and scope of the present disclosure. For example, the method 400 may perform additional, fewer, or different operations than those described in the present examples. For another example, the method 400 may be performed in a sequence of steps different from that described above. As yet another example, certain steps of the method 400 may be performed by other components than those described above.

In accordance with the foregoing, embodiments of the present systems and methods provide secure temporary privileged access to nodes in a cluster. To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks.

Program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices.

Similarly, operational data may be identified and illustrated herein within modules and may be embodied in any suitable form and organized within any suitable type of data structure. Operational data may be collected as a single data set or may be distributed over different locations including over different storage devices.

Reference is made herein to “configuring” a device or a device “configured to” perform some operation(s). This may include selecting predefined logic blocks and logically associating them. It may also include programming computer software-based logic of a retrofit control device, wiring discrete hardware components, or a combination thereof. Such configured devices are physically designed to perform the specified operation(s).

Various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. An Information Handling System (IHS) comprising:
a multi-cloud platform comprising a first and second clouds each supported by a first and a second server, respectively, that are heterogeneous relative to one another; and
at least one memory coupled to at least one processor, the at least one memory having program instructions stored thereon that, upon execution by the at least one processor, cause the instructions to:
receive, by a common workflow service, a request to copy storage data from the first server to the second server, wherein the common workflow service is agnostic to the specific procedures used by the first and second servers;
communicate, by the common workflow service, with a first server specific adapter service associated with the first server to obtain the storage data from the first server; and
communicate, by the common workflow service, with a second server specific adapter service associated with the second server to store the obtained storage data in the second server.

2. The IHS of claim 1, wherein the program instructions, upon execution, further cause IHS to store, by the second server specific adapter service, the storage data in a storage type that is different than a storage type stored in the first server.

3. The IHS of claim 2, wherein the storage type comprises at least one of a block storage, a file storage, or an object storage type.

4. The IHS of claim 1, wherein the program instructions, upon execution, further cause IHS to perform, by the second server specific adapter service, one or more procedures on the second server that is different than that performed on the first server, the one or more procedures comprising at least one of a snapshot management routine, a volume management routine, or a copy management routine.

5. The IHS of claim 1, wherein the first and second server specific adapter services are each agnostic to the overall mobility orchestration steps performed by the common workflow service.

6. The IHS of claim 1, wherein the first and second server specific adapter service is each unaware of whether the first and second servers are homogeneous or heterogeneous systems.

7. The IHS of claim 1, wherein the program instructions, upon execution, further cause IHS to execute each of the common workflow service and the first and second server specific adapter services in a Kubernetes POD.

8. The IHS of claim 1, wherein the program instructions, upon execution, further cause IHS to provide communication between the common workflow service and the first and second server specific adapter services using a Google Remote Procedure Call (gPRC) framework.

9. A data mobility method comprising:
receiving, by a common workflow service, a request to copy storage data from a first server to a second server, wherein the common workflow service is agnostic to the specific procedures used by the first and second servers, wherein the first and second servers are heterogeneous relative to one another and support first and second clouds, respectively, of a multi-cloud platform;
communicating, by the common workflow service, with a first server specific adapter service associated with the first server to obtain the storage data from the first server; and
communicating, by the common workflow service, with a second server specific adapter service associated with the second server to store the obtained storage data in the second server.

10. The data mobility method of claim 9, further comprising storing, by the second server specific adapter service, the storage data in a storage type that is different than a storage type stored in the first server.

11. The data mobility method of claim 9, further comprising performing, by the second server specific adapter service, one or more procedures on the second server that is different than that performed on the first server, the one or more procedures comprising at least one of a snapshot management routine, a volume management routine, or a copy management routine.

12. The data mobility method of claim 9, wherein the first and second server specific adapter services are each agnostic to the overall mobility orchestration steps performed by the common workflow service.

13. The data mobility method of claim 9, wherein the first and second server specific adapter service is each unaware of whether the first and second servers are homogeneous or heterogeneous systems.

14. The data mobility method of claim 9, further comprising executing each of the common workflow services and the first and second server specific adapter services in a Kubernetes POD.

15. The data mobility method of claim 9, further comprising providing communication between the common workflow service and the first and second server specific adapter services using a Google Remote Procedure Call (gPRC) framework.

16. A computer program product comprising a non-transitory computer readable storage medium having program instructions stored thereon that, upon execution by an Information Handling System (IHS), cause the IHS to:
receive, by a common workflow service, a request to copy storage data from a first server to a second server, wherein the common workflow service is agnostic to the specific procedures used by the first and second servers, wherein the first and second servers are heterogeneous relative to one another and support first and second clouds, respectively, of a multi-cloud platform;
communicate, by the common workflow service, with a first server specific adapter service associated with the first server to obtain the storage data from the first server; and
communicate, by the common workflow service, with a second server specific adapter service associated with the second server to store the obtained storage data in the second server.

17. The computer program product of claim 16, wherein the program instructions, upon execution, further cause IHS to store, by the second server specific adapter service, the storage data in a storage type that is different than a storage type stored in the first server, wherein the storage type comprises at least one of a block storage, a file storage, or an object storage type.

18. The computer program product of claim 16, wherein the program instructions, upon execution, further cause IHS to perform, by the second server specific adapter service, one or more procedures on the second server that is different than that performed on the first server, the one or more procedures comprising at least one of a snapshot management routine, a volume management routine, or a copy management routine.

19. The computer program product of claim 16, wherein the first and second server specific adapter services are each agnostic to the overall mobility orchestration steps performed by the common workflow service, and wherein the first and second server specific adapter service are each unaware of whether the first and second servers are homogeneous or heterogeneous systems.

20. The computer program product of claim 16, wherein the program instructions, upon execution, further cause IHS to provide communication between the common workflow service and the first and second server specific adapter services using a Google Remote Procedure Call (gPRC) framework.
